(19) United States
(12) Patent Application Publication
(10) Pub. No.: US 2013/0120207 A1
(43) Pub. Date: May 16, 2013

(54) ANTENNA MODULE

(71) Applicant: Hsiao-Ming TSAI, Taipei (TW)

(72) Inventor: Hsiao-Ming TSAI, Taipei (TW)

(21) Appl. No.: 13/612,530

(22) Filed: Sep. 12, 2012

(30) Foreign Application Priority Data
Nov. 11, 2011 (CN) 201110365156.6

(51) Int. Cl. H01Q 21/00; H01Q 9/16

(52) U.S. Cl. 343/793; 343/893

(57) ABSTRACT

An antenna module includes a substrate, a casing and at least two antennas. The substrate is disposed in the casing, and the antennas are disposed on the substrate and perpendicular to each other. Accordingly, the entire size of the antenna module can be decreased and it is still possible to provide the optimum signal transmission performance.

### CROSS REFERENCE TO RELATED APPLICATIONS

This Non-provisional application claims priority under 35 U.S.C. §119(a) on Patent Application No(s). 201110365156.6 filed in People's Republic of China on Nov. 11, 2011, the entire contents of which are hereby incorporated by reference.

### BACKGROUND OF THE INVENTION

1. Field of Invention

The present disclosure relates to an antenna module and, in particular, to an antenna module with antennas in a perpendicular arrangement.

2. Related Art

Antennas are an essential component of the wireless communication apparatus and are configured for transmitting and receiving communication signals. Although the wireless communication technology has been developed for a long time, the antenna is still an indispensable component. Nowadays, the wireless communication contains low frequency and high frequency transmissions and is applied to military and telecommunication as well as the common information and consumer electronic products. To satisfy the wide applications, the antennas must be properly design with respect to the various systems.

IEEE 802.11 is the most commonly used protocol for wireless local area network. In particular, IEEE 802.11 n can support the MIMO (multi-input multi-output) technology for transmitting and/or receiving signals. FIG. 1 is a schematic diagram showing a conventional antenna module 1. As shown in FIG. 1, the antenna module 1 includes a main body 11 and three dipole antennas 12. The dipole antennas 12 are all disposed on the main body 11, and located at one side of the main body 11 in parallel. Under the MIMO system, when two dipole antennas 12 perform the transmission and receiving functions simultaneously, the isolation between the antennas 12 must be greater than 15 dB, so that the antenna module 1 can achieve the optimum performance in MIMO. Similarly, under the MIMO system, when three dipole antennas 12 are configured, they must be arranged with a specific distance so as to achieve the required isolation of 15 dB. For example, when the operation frequency is 2.45 GHz, the distance between any two of the dipole antennas 12 must be larger than 8 cm so as to achieve the required isolation of 15 dB. Accordingly, when the antenna module 1 has three dipole antennas 12, one side of the antenna module 1 must be greater than 16 cm. This configuration increases the entire volume of the system, thereby needing more material cost and affecting the appearance.

### SUMMARY OF THE INVENTION

The disclosure provides an antenna module having novel antenna arrangement, thereby decreasing the entire volume so as to reduce the required installing space and thus achieving the optimum signal transmission performance in MIMO.

An antenna module of this disclosure includes a substrate, a casing, and at least two antennas. The substrate is disposed in the casing. The antennas are disposed on the substrate and perpendicular to each other. Each of the antennas has an end point, and a distance is configured between the end points of the antennas. In addition, an included angle is configured between the antennas.

In one embodiment, the antennas are disposed at edges or corners of the substrate.

In one embodiment, the included angle is between 85 degrees and 95 degrees.

In one embodiment, the distance between the end points is larger than 1 cm.

In one embodiment, the antennas are electrically connected to the substrate through electrical connecting elements, and the electrical connecting element comprises a cable or a connector.

In one embodiment, the antennas comprise a dipole antenna, and each of the antennas has at least one of transmission and receiving functions.

In one embodiment, the shape of the casing is pyramid, semi-sphere, or umbrella-like.

The antenna module of this disclosure has the above-mentioned features so that its entire volume can be decreased and it still has equivalent signal transmission performance as the conventional antenna module. In addition, the antenna module of this disclosure can be perfectly applied to the MIMO antenna technology.

These and other features, aspects and advantages of the present invention will become better understood with regard to the following description, appended claims, and accompanying drawings.

### BRIEF DESCRIPTION OF THE DRAWINGS

FIG. 1 is a schematic diagram of a conventional antenna module;

FIG. 2A is a schematic diagram of an antenna module according to an embodiment of this disclosure;

FIG. 2B is a side view of the antenna module of FIG. 2A;

FIG. 3A is a schematic diagram of another antenna module according to the embodiment of this disclosure;

FIG. 3B is a top view of the antenna module of FIG. 3A; and

FIG. 4 is a graph showing the impedance diagram of the antenna module of FIG. 3A.

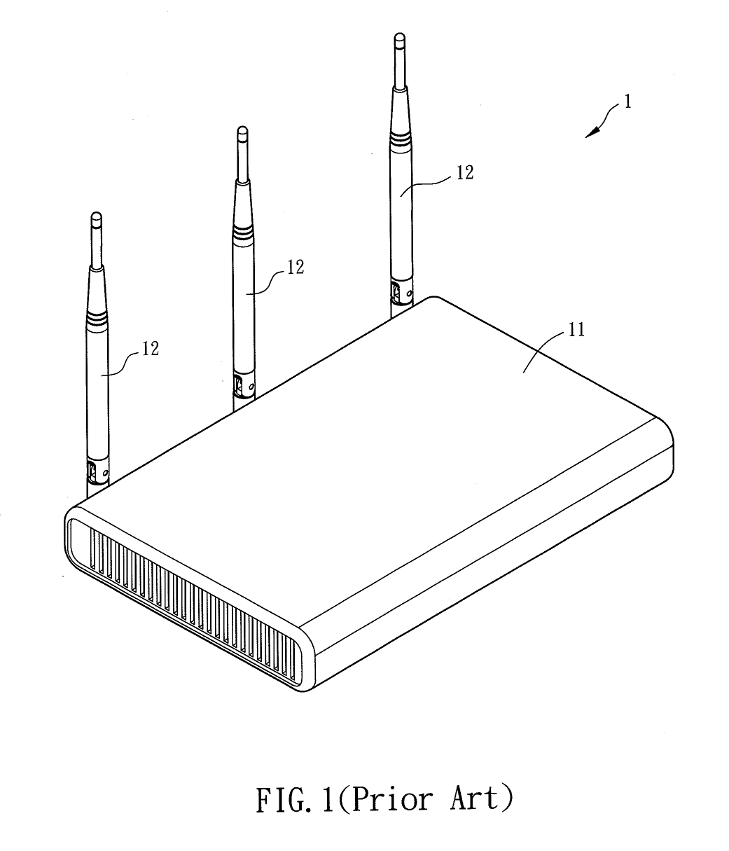

### DETAILED DESCRIPTION OF THE INVENTION

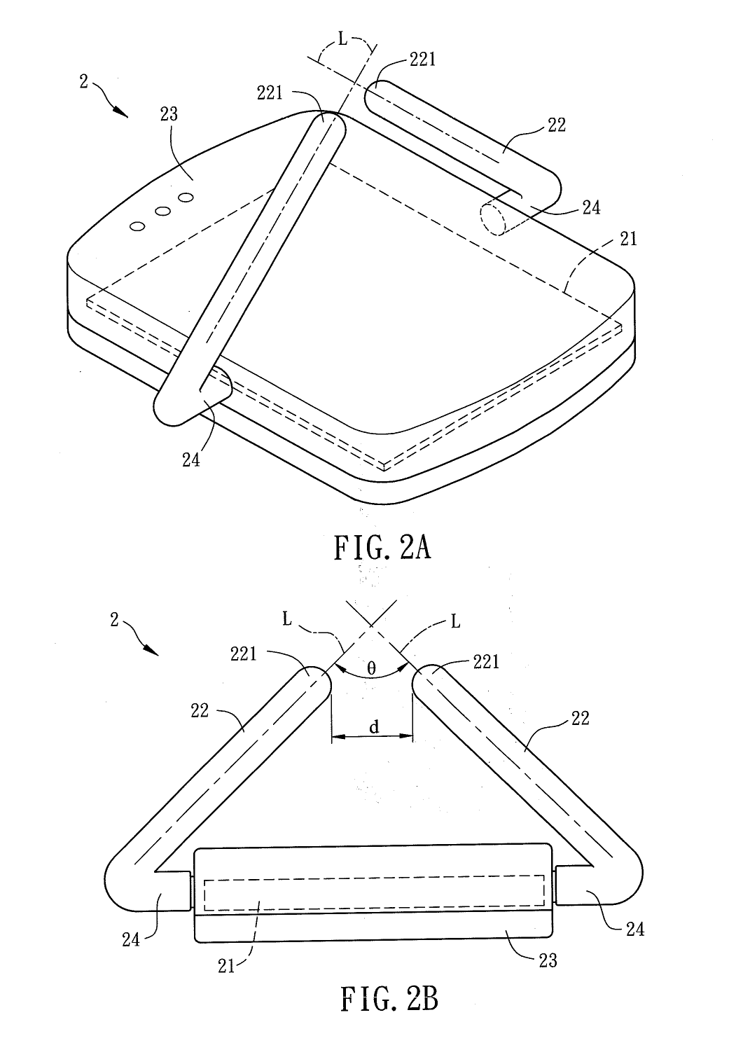

FIG. 2A is a schematic diagram of an antenna module 2 according to an embodiment of this disclosure. Referring to FIG. 2A, the antenna module 2 includes a substrate 21 and at least two antennas 22. The antenna module 2 of this embodiment is applied to MIMO. To be noted, the antenna module 2 of this embodiment includes two antennas 22 for example, but the disclosure is not limited to this case. In other embodiments, the antenna module may include three antennas according to the desired signal transmission intensity, functions or signal flux.

The shape of the substrate 21 can be square, triangular, circular, star-shaped, umbrella-shaped or irregular. The substrate 21 of this embodiment is, for example but not limited to, square. In addition, the substrate 21 of this embodiment is a circuit board.

The antennas 22 are separately disposed at the edges or corners of the substrate 21. In this case, the antennas 22 are disposed at two edges of the substrate 21, respectively. The antenna 22 can be electrically connected to the substrate 21 through an electronic connecting element (not shown), so that the substrate 21 can receive or transmit signals through the antennas 22. The electronic connecting element includes a cable, a connector, or any applicable electronic connecting elements.

FIG. 2B is a side view of the antenna module 2 of FIG. 2A. With reference to FIGS. 2A and 2B, an included angle 8 is configured between the two antennas 22 (or between the dotted lines L). In this embodiment, the antennas 22 are perpendicular to each other. To be noted, since the positions or angles of the antennas 22 may be shifted due to the environmental factors or external forces, the antennas 22 are not perfectly perpendicular to each other and thus the included angle θ may be slightly larger or smaller than 90 degrees. Accordingly, the included angle θ is preferably ranged from 85 to 95 degrees, which all substantially refer to “in perpendicular to each other”. Within this range of the included angle θ, the antenna module 2 can still achieve the optimum signal transmission and receiving functions.

Each antenna 22 has an end point 221 that is closest to the other antenna 22 as shown in FIG. 2B. A distance d is configured between the end points 221 and is preferably larger than 1 cm. That is, the antennas 22 of this embodiment are not in contact with each other. When the distance d between the end points 221 of the antennas 22 remains in larger than 1 cm, the isolation between the two antennas 22 can be kept in larger than 15 dB.

The antennas 22 of this embodiment include a dipole antenna, which can perform the receiving and transmitting functions simultaneously, so the antenna module 2 of this embodiment can be applied to MIMO application. Of course, the antennas 22 of this embodiment can perform either the receiving function or the transmitting function.

The antenna module 2 further includes a casing 23, and the substrate 21 is disposed in the casing 23. The casing 23 of this embodiment is configured for covering and protecting the substrate 21 so as to prevent the malfunction or damage of the substrate 21 caused by dusts, weather or other external factors. The shape of the casing 23 can be designed according to the shape of the substrate 21, and moreover, the casing 23 can be designed based on the number of the antennas 22. For example, the triangle casing is suitable for installing three antennas. This case is for illustration only and is not to limit the present disclosure. In practice, the shape of the casing 23 may be square, triangular, circular, star-shaped, pyramid, semi-sphere, umbrella-shaped or irregular.

In addition, the antenna module 2 of this embodiment may further include a plurality of restricting elements 24 disposed at two edges of the antennas 22 or connected to the antennas 22 so as to fixing the angles of the antennas 22. In other embodiments, the restricting elements 24 may also be disposed around the casing 23 for restricting and fixing the positions of the antennas 22. The restricting elements 24 of this embodiment are, for example but not limited to, cylindrical frames. Of course, the restricting elements can be designed in different shapes and dimensions depending on different installation environments and aspects.

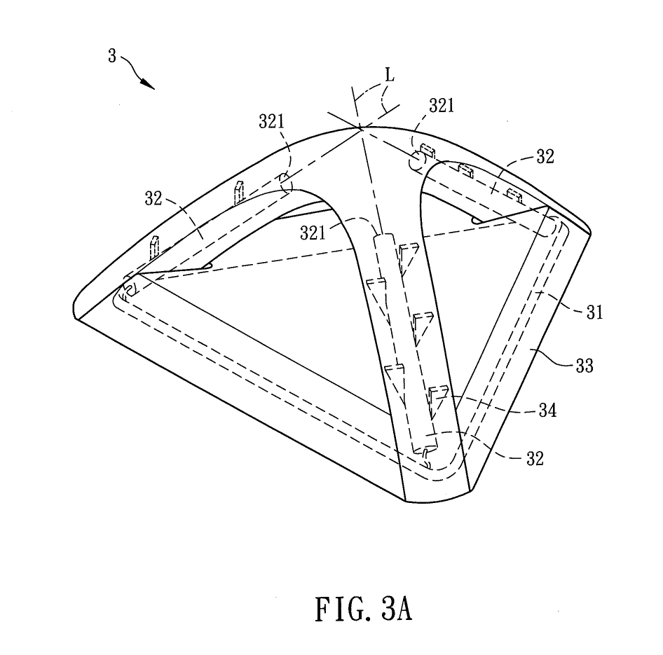

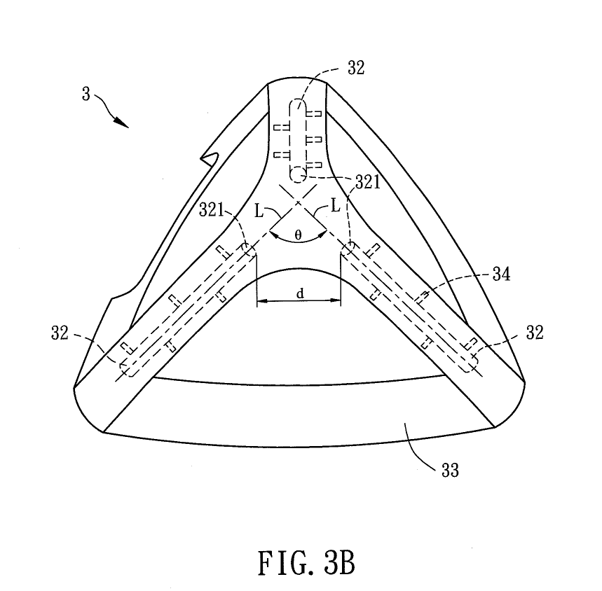

FIG. 3A is a schematic diagram of another antenna module 3 according to the embodiment of this disclosure. Most features and structures of the antenna module 3 are similar to those of the antenna module 2, so the similar part will be omitted while the different part will be described hereinafter.

The casing 33 of this embodiment is pyramid, and the substrate 31 and the antennas 32 are all disposed in the casing 33. The casing 33 can not only cover and protect the substrate 31 and the antennas 32, but also restrict the positions of the antennas 32. This configuration can avoid the shift of the antennas 32 caused by external forces and thus remain the signal transmission performance. In this case, the dimension or internal structure of the casing 33 can be properly designed to restrict the positions of the antennas 32. Moreover, it is also possible to configure several restricting elements 34 in the casing 33 for restricting and fixing the positions of the antennas 32. In practice, the restricting elements 34 can be screws, iron plates, frames, or any other fixing elements.

The antenna module 3 includes three antennas 32, which are disposed at three corners of the casing 33 and electrically connected to the substrate 32 through cables.

FIG. 3B is a top view of the antenna module 3 of FIG. 3A. As shown in FIGS. 3A and 3B, any two of the antennas 32 are perpendicular to each other, and an included angle θ is configured between any two antennas 32 (or between the dotted lines L). The included angle θ is ranged from 85 to 95 degrees, and is preferably 90 degrees. In addition, each antenna 32 has an end point 321 that is closest to the other antennas 32, and a distance d is configured between the end points 321 of two antennas 32 and is preferably larger than 1 cm. Thus, the isolation between the antennas 32 can be remained.

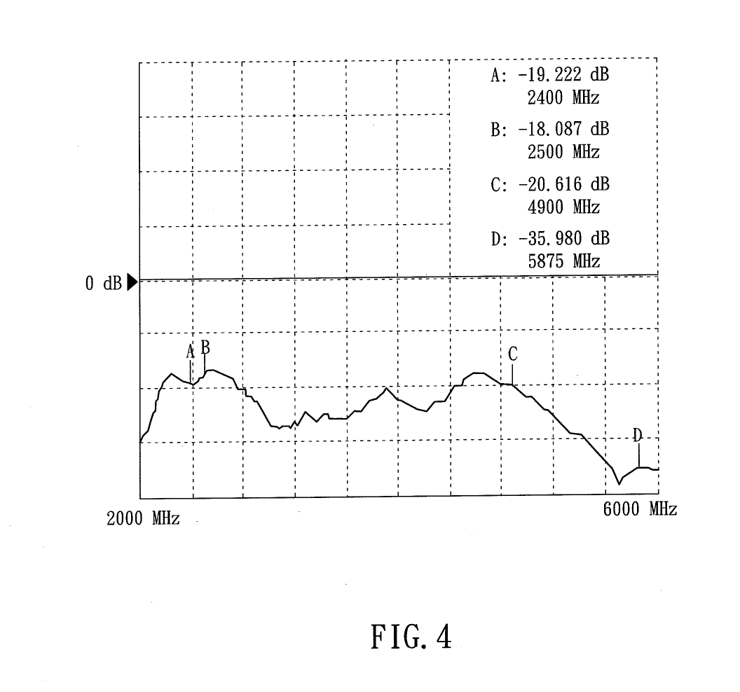

FIG. 4 is a graph showing the waveform diagram of the antenna module 3 of FIG. 3A. To be noted, FIG. 4 is an impedance diagram showing the testing result of the antenna module 3 of FIG. 3A. The antenna module 3 includes three antennas 32, and any two antennas 32 have an included angle of 90 degrees therebetween. Besides, a distance between the end points 321 of two antennas 32 is larger than 1 cm. In this impedance diagram, the testing point A applied to 2.4 GHz has an isolation of 19.2 dB, the testing point B applied to 2.5 GHz has an isolation of 18.08 dB, the testing point C applied to 4.9 GHz has an isolation of 20.6 dB, and the testing point D applied to 5.87 GHz has an isolation of 35.9 dB. According to the test results, the measured isolations of the antenna module 3 in different bandwidths are all larger than 15 dB and, even more, larger than 18 dB, so that the antenna module 3 can achieve the optimum signal transmission performance.

In summary, the antenna module of this disclosure includes at least two antennas disposed on the substrate and perpendicular to each other. Each of the antennas has an end point, which is closest to the other antenna, and a distance between the end points of the antennas is preferably larger than 1 cm. Accordingly, the antenna module of this disclosure can have minimized volume and still have equivalent signal transmission performance as the conventional art. Besides, the antenna module of this disclosure can be applied to the MIMO applications.

Compared with the conventional art, the antenna module of this disclosure with novel antenna arrangement can minimize the entire volume, decrease the manufacturing cost and the occupied space, become more convenient in operation, and be capable of achieving the optimum signal transmission performance.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An antenna module, comprising:
a substrate;
a casing, wherein the substrate is disposed in the casing; and
at least two antennas disposed on the substrate, wherein the antennas are perpendicular to each other;
wherein each of the antennas has an end point, a distance is formed between the end points of the antennas, and an included angle is formed between the antennas.

2. The antenna module of claim 1, wherein the substrate is square, triangular, circular, star-shaped, or irregular.

3. The antenna module of claim 1, wherein the antennas are disposed at edges or corners of the substrate.

4. The antenna module of claim 1, wherein the included angle is between 85 degrees and 95 degrees.

5. The antenna module of claim 1, wherein the distance between the end points is larger than 1 cm.

6. The antenna module of claim 1, wherein the antennas are electrically connected to the substrate through electrical connecting elements.

7. The antenna module of claim 6, wherein the electrical connecting element comprises a cable or a connector.

8. The antenna module of claim 1, wherein the antennas comprise a dipole antenna.

9. The antenna module of claim 1, wherein each of the antennas has at least one of transmission and receiving functions.

10. The antenna module of claim 1, wherein the shape of the casing is pyramid, semi-sphere, or umbrella-like.
